(19) United States
(12) Patent Application Publication
(10) Pub. No.: US 2023/0383832 A1
(43) Pub. Date: Nov. 30, 2023

(54) GEARWHEEL, METHOD FOR PRODUCING A GEARWHEEL, AND METHOD FOR MEASURING A GEARWHEEL

(71) Applicant: Klingelnberg AG, Zürich (CH)

(72) Inventor: Rolf Schalaster, Wermelskirchen (DE)

(21) Appl. No.: 18/320,555

(22) Filed: May 19, 2023

(30) Foreign Application Priority Data
May 25, 2022 (EP) 22175584.6

(51) Int. Cl. F16H 55/08; B23F 23/12; B23F 9/02

(52) U.S. Cl. CPC F16H 55/08; B23F 23/1218; B23F 9/02

(57) ABSTRACT

A gearwheel, wherein the gearwheel has a setpoint geometry, wherein the gearwheel has a modification superimposed on the setpoint geometry in the form of a pitch and/or topography changing from tooth to tooth, wherein a variation of the pitch and/or topography specified by the modification, observed over a total number of teeth of the gearwheel, corresponds to a superposition of at least two harmonic functions, which differ from one another in one parameter or in multiple parameters, such as their amplitude, frequency, or phase shift.

### CROSS-REFERENCE TO RELATED APPLICATIONS

This application claims the benefit of European patent application no. 22175584.6, filed on 25 May 2022, the disclosure of which is incorporated herein by reference in its entirety.

### TECHNICAL FIELD

The present disclosure relates to a gearwheel, wherein the gearwheel has a setpoint geometry and wherein the gearwheel has a modification, superimposed on the setpoint geometry, in the form of a pitch and/or topography changing from tooth to tooth. Furthermore, the disclosure relates to a method for producing a gearwheel and a method for measuring a gearwheel.

### BACKGROUND

In modern motor vehicles having solely electric-motor drive or having a hybrid drive, the transmission noise is no longer masked completely or is masked less strongly by the motor noise, since the motors thereof operate with lower noise in comparison to the engines of solely combustion-engine drives, such as conventional diesel or gasoline engines. The transmission noise can therefore be noticed by the vehicle occupants and perceived as annoying.

The noise behavior of a transmission is primarily caused by the excitation in the tooth engagement of the mutually meshing gearwheel pairs. The modification mentioned at the outset, which is superimposed on the setpoint geometry, in the form of a pitch and/or topography changing from tooth to tooth, causes splitting of the tooth engagement frequency and its harmonics to adjacent frequencies, in order to improve the subjective noise behavior of the gearwheel in the transmission.

Such an approach is described, for example, in “Reducing the tonality of gear noise by application of topygraphy scattering for ground bevel gears”, appearing in the magazine “GearSolutions”, issue May 2021. A random modification, in the form of a stochastic pitch error profile and stochastic topographic flank modifications, within the limits of the provided tolerance class, is applied to bevel gear teeth in order to improve the subjective noise behavior of the relevant gear teeth.

The subjective noise behavior relates to the perception of noises by humans. Thus, for example, two noises which have the same volume can be perceived as differently annoying by humans, dependent on the frequencies of which the relevant noise is composed and how dominant these frequencies are as a whole in comparison to the noise component of the relevant noise. Improving the subjective noise behavior of a transmission is also referred to as psychoacoustic optimization of the transmission noise. The goal of such psychoacoustic optimization of the transmission noise is to increase the noise component of the transmission noise and reduce the tonality of a transmission noise spectrum.

The procedure known in the above-mentioned article from the magazine “GearSolutions”, of providing randomly distributed modifications on a gearwheel, has the disadvantage that upon measurement of the geometry of such a gearwheel in relation to the specified, non-noise-optimized setpoint geometry, large deviations are possibly detected, depending on which teeth of the gearwheel have been measured. It is thus typical to only measure three or four teeth or gaps of a gearwheel distributed around the circumference of the gearwheel and to determine average deviations from these measurements in order to derive corrections for the manufacturing process. However, the randomly distributed modifications can therefore have the result that as a result of the measurement of few teeth, large average deviations are detected, which are not representative of the entire gearwheel and do not have to be corrected. The correction method therefore cannot be carried out reliably.

In order to enable reasonable measurement here in spite of the randomly distributed modifications, a measurement of all teeth or gaps has to be carried out for each gearwheel or, if only a few teeth are measured, as is typical, the precise tooth-specific or gap-specific noise-optimized setpoint geometry has to be provided with its respective tooth-specific or gap-specific modification in a measuring machine and a measurement and evaluation of deviations has to take place specifically by tooth or gap in relation to this tooth-specific or gap-specific noise-optimized setpoint geometry. This procedure is linked to a high level of effort and only has limited practicality.

### SUMMARY

Against this background, the present disclosure is based on the technical problem of specifying a gearwheel having a modification superimposed on the setpoint geometry in the form of a pitch and/or topography changing from tooth to tooth, which has improved subjective noise behavior and the quality of which can be checked on the basis of a measurement in relation to its setpoint geometry without a tooth-specific or gap-specific consideration of the modification. Furthermore, a method for producing such a gearwheel and a method for measuring such a gearwheel are to be specified.

According to a first aspect, the disclosure relates to a gearwheel, wherein the gearwheel has a setpoint geometry and wherein the gearwheel has a modification superimposed on the setpoint geometry in the form of a pitch and/or topography changing from tooth to tooth. The gearwheel is distinguished in that a variation of the pitch and/or topography specified by the modification corresponds, viewed over a total number of teeth of the gearwheel, to a superposition of at least two harmonic functions, which different from one another in one parameter or in multiple parameters, such as their amplitude, frequency, or phase shift.

When reference is made in the present text to the setpoint geometry, in this case this is the setpoint geometry of the gearwheel without the modification superimposed on the setpoint geometry. When reference is made in the present text to a noise-optimized setpoint geometry, in this case this is the setpoint geometry of the gearwheel with the modification superimposed on the setpoint geometry.

The modification according to the disclosure causes improved noise behavior of the gearwheel, wherein the quality of the gearwheel can be checked on the basis of a measurement in relation to its setpoint geometry without a tooth-specific or gap-specific consideration of the modification. I.e., in spite of the modification superimposed on the setpoint geometry, the deviations of the gearwheel can still be ascertained in relation to the setpoint geometry and not in relation to the noise-optimized setpoint geometry, so that the noise-optimized setpoint geometry does not have to be made available to a measuring machine.

Due to the use of a superposition of at least two harmonic functions in order to predetermine the variation, an average deviation in relation to the setpoint geometry resulting due to the modification, for example, can be less than 25% of the amplitude or total amplitude of the superposition—and independently of which teeth or gaps of the gearwheel are evaluated in the course of an observation of, for example, 3 or 4 teeth of the gearwheel. The scatter of the measurement results, which arises as a function of the selection of the measured teeth or gaps, is therefore very small, so that any teeth or gaps can be measured and evaluated and correction parameters can still be determined for a manufacturing process on the basis of these average deviations.

Depending on the number of the superimposed functions and their frequencies, viewed over the total number of teeth, a variation can be generated which appears comparable to a random variation, if only the detail of the superposition relating to the total number of teeth is observed.

It can be provided that an amplitude or total amplitude of the superimposed harmonic functions is specified, which is within a specified tolerance range of the gearwheel, wherein the total amplitude is allocated on the amplitudes of the superimposed harmonic functions. It can thus be ensured that the gearwheel can be manufactured reliably within the specified tolerance limits.

According to one embodiment of the gearwheel, it can be provided that the superimposed harmonic functions each differ from one another both with respect to their amplitude and also their frequency and also their phase shift.

According to one embodiment of the gearwheel, it can be provided that the superimposed harmonic functions each differ from one another with respect to their frequency and their phase shift.

For example, it can be provided that precisely three harmonic functions are superimposed.

When reference is made in the present case to harmonic functions, these can be, for example, functions by which harmonic oscillations may be described, such as trigonometric functions or the like, in particular sine functions and/or cosine functions.

In particular, the modification can be specified in that each tooth is assigned a deviation as a function value of the superimposed harmonic functions.

It can be provided that the superimposed harmonic functions are sine functions, wherein each tooth is assigned a deviation as a function value f(x) according to the following rule: f(x)=

$${K}_{max} * {\sum }_{i = 1}^{n} {A}_{i} * sin ( 2 * π * ( {ϕ}_{i} + {ω}_{i} \frac{( x - 1 )}{Z} ) ) ,$$

wherein Kₘₐₓ corresponds to a maximum deviation of a toothing parameter or a process parameter, wherein “i” corresponds to a running index, wherein “n” corresponds to a number of the specified superimposed sine functions, wherein the variable “Z” corresponds to the total number of teeth of the gearwheel, wherein the variable “A t” corresponds to a specified amplitude of a respective “i”-th sine function, wherein the variable “0,” corresponds to a specified phase shift of a respective “i”-th sine function, wherein the variable “co,” corresponds to a specified frequency of a respective “i”-th sine function, and wherein the variable “x” is a natural number with x=1 to x=Z, wherein “x” moreover corresponds to a number of a relevant tooth increasing from 1 to Z, and wherein the teeth are continuously numbered successively clockwise or counterclockwise. Function f(x) therefore defines, for each natural number x from x=1 to x=Z inclusive, a deviation to be assigned to the respective tooth.

Kₘₐₓ can be in this case, for example, a pitch deviation, a spiral angle error, or another toothing parameter directly defining the geometry of a gearwheel or bevel gear. Kₘₐₓ can be in this case, for example, a deviation of an axis position of a gear cutting machine during the gearwheel production or a deviation of a radial in the context of the bevel gear design, i.e., a process parameter indirectly defining the geometry of a gearwheel or bevel gear.

It is obvious that the deviations can additionally or alternatively be assigned to the gaps of the gearwheel instead of teeth of the gearwheel. This is because with respect to gearwheel production, reference is always made in the literature to manufacturing of gaps instead of manufacturing of teeth, since the teeth of the gearwheel are formed or worked out of a gearwheel blank by producing the gaps.

It can be provided that the variation of the pitch and/or topography specified by the modification corresponds, viewed over the total number of teeth of the gearwheel, to a superposition of precisely three sine functions.

According to one embodiment of the gearwheel, it is provided that a deviation from the setpoint geometry, which results due to the modification superimposed on the setpoint geometry and is averaged over two or more teeth of the gearwheel, corresponds to less than 30% of a total amplitude of the superposition of the at least two harmonic functions, in particular corresponds to less than 25% of the total amplitude of the superposition of the at least two harmonic functions.

For example, it can be provided that a deviation from the setpoint geometry, which results due to the modification superimposed on the setpoint geometry and is averaged over two or more teeth, corresponds to less than 25% of a total amplitude of the superposition of precisely three sine functions.

According to one embodiment of the gearwheel, it is provided that the frequency of the respective harmonic function, which corresponds to a number of cycles of the respective harmonic function viewed over the total number of teeth, is less than the total number of teeth of the gearwheel.

In particular, the frequency of a respective harmonic function is not equal to 1 here, which this frequency adds to the concentricity error.

In particular, the frequency of the respective harmonic function can be adapted to the normal number of teeth to be measured typical for the relevant gearwheel, wherein in particular no frequency ωhich corresponds to the number of the teeth to be measured is used. If typically 3 or 4 teeth are measured distributed over the circumference on a gearwheel having, for example, 13 teeth in the context of the quality control, the frequencies 1, 3, 4 thus should not be used as frequencies for the respective superimposed harmonic functions for example, the frequencies 2, and Z−2=11 can be used for such a gearwheel, if, for example, three superimposed sine functions are used as the superimposed harmonic functions.

According to one embodiment of the gearwheel, it is provided that the amplitudes of the superimposed harmonic functions cancel out for a tooth and the modification for this tooth of the gearwheel is zero. If the modification for this tooth or this gap of the gearwheel is zero, in this case this can be, for example, a first tooth characterized as such or a first gap of the gearwheel characterized as such, which can be found within a measuring machine and which represents the first tooth or the first gap which is measured first in a measurement sequence and on the basis of which the numbering of the further teeth or gaps clockwise or counterclockwise is specified.

It can be provided that the setpoint geometry of the gearwheel has toothing modifications, such as recesses, crowning, or the like. I.e., the setpoint geometry can have toothing modifications which apply and are defined similarly for all teeth, while the claimed superimposed modification is additionally applied to the setpoint geometry having these toothing modifications, wherein the setpoint geometry having the toothing modifications including this superimposed modification results in the noise-optimized setpoint geometry. I.e., the setpoint geometry includes the flank topography specified in the same way for each tooth or each gap, which can include toothing modifications, while a flank topography different from tooth to tooth is generated by the modification superimposed on this setpoint geometry in order to improve the subjective noise behavior of the gearwheel.

According to one embodiment of the gearwheel, it is provided that the gearwheel is a bevel gear, in particular a bevel gear produced by single indexing. The bevel gear can be, for example, a bevel gear produced by single indexing in the rolling method. The bevel gear can be, for example, a bevel gear produced by single indexing in the plunging method.

According to a second aspect, the disclosure relates to a method for producing a gearwheel, having the following method steps: specifying a setpoint geometry of the gearwheel; specifying a modification superimposed on the setpoint geometry in the form of an index and/or topography changing from tooth to tooth; producing the gearwheel by means of a gear cutting machine. The method is distinguished in that a variation of the indexing and/or topography specified by the modification, viewed over a total number of teeth of the gearwheel, corresponds to a superposition of at least two harmonic functions which differ from one another in one parameter or in multiple parameters, such as their amplitude, frequency, or phase shift.

It can be provided that the manufacturing of each gap or each tooth of the gearwheel is carried out using gap-specific or tooth-specific machine settings in order to manufacture the setpoint geometry having the superimposed modification, wherein the gearwheel is in particular a bevel gear which is produced in the single indexing method.

According to one embodiment of the method, it can be provided that the gearwheel is a bevel gear which is produced in the single indexing method, wherein a design parameter of a virtual gear cutting machine, such as a radial for influencing the spiral angle or the like, which are converted into manufacturing parameters of the gear cutting machine, is varied specifically by gap or tooth, in order to manufacture the setpoint geometry having the superimposed modification. The modification superimposed on the setpoint geometry can already be specified via design parameters in the design of the bevel gear, such as the radial or the like.

It can be provided that a manufacturing parameter of the gear cutting machine, such as a movement of a linear axis or a workpiece axis, is varied specifically by gap or tooth in order to manufacture the setpoint geometry having the superimposed modification. The modification superimposed on the setpoint geometry can therefore be specified via manufacturing parameters of the gear cutting machine.

According to a third aspect, the disclosure relates to a method having the following method steps: providing a gearwheel according to the disclosure and measuring the gearwheel by means of a gear cutting machine, wherein deviations of the gearwheel in relation to the setpoint geometry are ascertained, wherein the modification superimposed on the setpoint geometry is not part of the setpoint geometry.

The gearwheel is therefore measured in relation to the setpoint geometry and not in relation to the noise-optimized setpoint geometry, which consists of the setpoint geometry plus the modification superimposed on the setpoint geometry.

Due to the use of the superposition of at least two harmonic functions in order to predetermine the variation, it is possible for an average deviation measured due to the modification, for example, in relation to the setpoint geometry to be less than 25% of the amplitude or total amplitude of the superposition—and independently of which teeth or gaps of the gearwheel are evaluated in the course of a measurement of, for example, 3 or 4 teeth of the gearwheel. The scatter of the measurement results which arises as a function of the selection of the measured teeth or gaps is therefore very small, so that any teeth or gaps can be measured and evaluated.

It can be provided that a number of teeth are measured on the gearwheel which is less than the total number of teeth of the gearwheel, wherein in particular fewer than half of the teeth of the gearwheel are measured or in particular precisely three or four teeth of the gearwheel are measured, wherein an average deviation to the setpoint geometry is determined on the basis of the measured teeth.

According to one embodiment of the method, it is provided that corrections for a grinding method of the gearwheel are determined on the basis of the average deviations.

### BRIEF DESCRIPTION OF THE DRAWINGS

The disclosure is described in more detail hereinafter on the basis of a drawing illustrating exemplary embodiments. In the schematic figures:

FIG. 1 shows a spur gear according to the disclosure in a side view;

FIG. 2 shows an illustration of a variation of a pitch of the gearwheel from FIG. 1 viewed over a total number of teeth of the gearwheel;

FIG. 3 shows a further illustration of the function underlying the variation of the pitch of the gearwheel from FIG. 2;

FIG. 4 shows an illustration of a variation of a pitch of a further gearwheel viewed over a total number of teeth of the further gearwheel;

FIG. 5 shows a further illustration of the function underlying the variation of the pitch of the gearwheel according to FIG. 4;

FIG. 6 shows a bevel gear according to the disclosure in a perspective view from above;

FIG. 7 shows a detail enlargement of the bevel gear from FIG. 6;

FIG. 8 shows a flow chart of a method according to the disclosure;

FIG. 9 shows a gear cutting machine;

FIG. 10 shows a bevel gear with a bar cutter head;

FIG. 11 shows a bevel gear with a bar cutter head and a virtual crown gear;

FIG. 12 shows a bevel gear with a tool having parameters of a virtual gear cutting machine;

FIG. 13 shows the bevel gear from FIG. 12 with the tool and with further parameters of the virtual gear cutting machine;

FIG. 14 shows a toothing measuring machine; and

FIG. 15 shows a flow chart of a further method according to the disclosure.

### DETAILED DESCRIPTION OF THE DRAWINGS

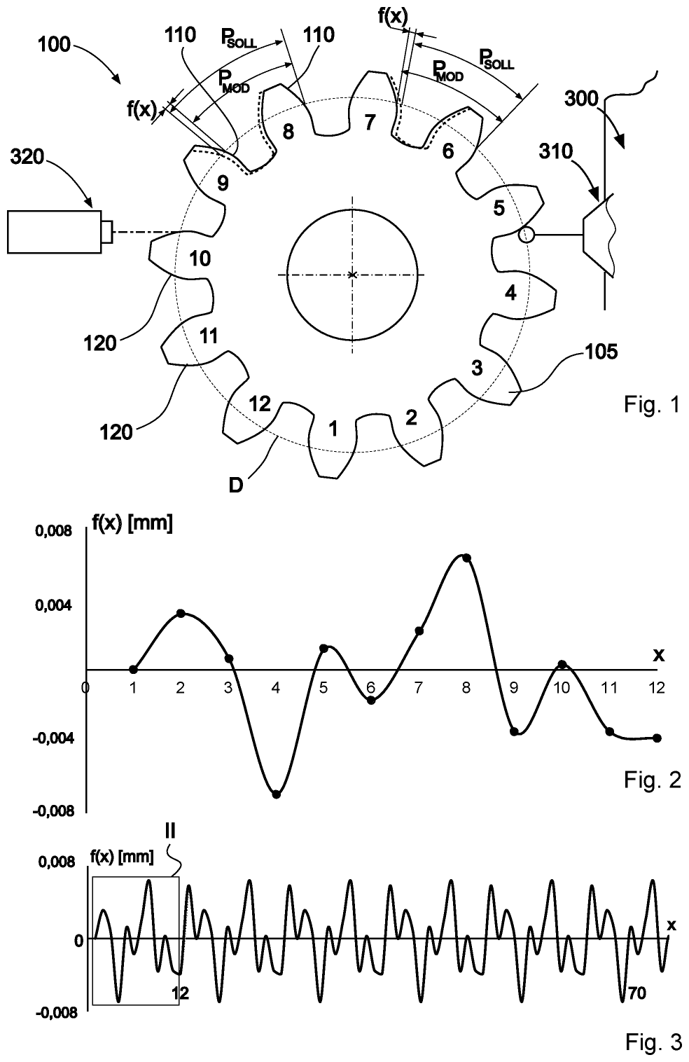

FIG. 1 shows a gearwheel 100 having twelve teeth 105, which are continuously numbered successively counterclockwise from 1 to 12. The gearwheel 100 is a spur gear. The gearwheel has a setpoint geometry, which specifies the shape of right flanks 110 and left flanks 120 and a setpoint pitch P_{SOLL} on the pitch circle D.

The gearwheel 100 has a modification superimposed on the setpoint geometry in the form of a pitch P_{MOD} changing from tooth to tooth, which can also be designated in the present case as a modified pitch or noise-optimized pitch.

The variation of the pitch P_{MOD} specified by the modification corresponds in the present case, viewed over a total number of teeth Z=12 of the gearwheel 100, to a superposition of precisely three sine functions (FIG. 2).

The superimposed harmonic functions are three sine functions in the present example, wherein the deviation is assigned to each tooth as a function value f(x) according to the following general rule

$$f ( x ) = {K}_{max} * {A}_{1} * sin ( 2 * π * ( {ϕ}_{1} + {ω}_{1} \frac{( x - 1 )}{Z} ) ) + {K}_{max} * {A}_{2} * sin ( 2 * π * ( {ϕ}_{2} + {ω}_{2} \frac{( x - 1 )}{Z} ) ) + {K}_{max} * {A}_{3} * sin ( 2 * π * ( {ϕ}_{3} + {ω}_{3} \frac{( x - 1 )}{Z} ) ) ,$$

wherein the following numeric values are used in the present example according to FIG. 2

$$f ( x ) = 0.015 mm * 0.4 * sin ( 2 * π * ( 0.11 + 2 * \frac{( x - 1 )}{12} ) ) + 0.015 mm * 0.3 * sin ( 2 * π * ( 0.66 + 5 * \frac{( x - 1 )}{12} ) ) + 0.015 mm * 0.3 * sin ( 2 * π * ( 0 + 11 * \frac{( x - 1 )}{12} ) ) ,$$

wherein for the first sine function the amplitude A₁=0.4, the frequency ω₁=2, and the phase shift ϕ₁=0.11 are specified, wherein for the second sine function the amplitude A₂=0.3, the frequency ω₂=5, and the phase shift ϕ₂=0.66 are specified, and wherein for the third sine function the amplitude A₃=0.3, the frequency ω₃=11, and the phase shift ϕ₃=0 are specified. Kₘₐₓ corresponds in this example to a pitch error of at most 0.015 mm, which is proportionally superimposed on the teeth 105 of the gearwheel 100 by means of the sine functions.

The following deviations f(x) result therefrom for each tooth 1 to 12 (see FIG. 2):

| Tooth | $\begin{matrix}{\sum }_{i = 1}^{n} {A}_{i} * \\ sin ( 2 * π * ( {ϕ}_{i} + {ω}_{i} \frac{( x - 1 )}{Z} ) )\end{matrix}$ | $\begin{matrix}{K}_{max} * {\sum }_{i = 1}^{n} {A}_{i} * \\ sin ( 2 * π * ( {ϕ}_{i} + {ω}_{i} \frac{( x - 1 )}{Z} ) )\end{matrix}$ |
|---|---|---|
| 1 | 0.002 | 0.00003 mm |
| 2 | 0.235 | 0.00353 mm |
| 3 | 0.046 | 0.00069 mm |
| 4 | −0.522 | −0.00783 mm |
| 5 | 0.088 | 0.00011 mm |
| 6 | −0.127 | −0.00191 mm |
| 7 | 0.161 | 0.00242 mm |
| 8 | 0.47 | 0.00705 mm |
| 9 | −0.26 | −0.00390 mm |
| 10 | 0.022 | 0.00033 mm |
| 11 | −0.261 | −0.00392 mm |
| 12 | −0.288 | −0.00432 mm |

A deviation from the setpoint geometry, which results due to the modification superimposed on the setpoint geometry and is averaged over three or four teeth 105 of the gearwheel 100, is less than 25% of the total amplitude of the superposition of the sine functions. Three or four teeth are typically observed here, which have a spacing of two or three teeth from one another, i.e., are arranged distributed over the circumference of the gearwheel.

In FIG. 3, the function f(x) has been shown for function values from x=1 to x=75, in order to better illustrate the superimposed harmonic sine functions. The illustration of FIG. 2 is therefore a detail II from FIG. 3.

In the above-mentioned example, a gearwheel having an even number of teeth is shown. The described procedure may be transferred as desired to gearwheels having an odd number of teeth and higher number of teeth.

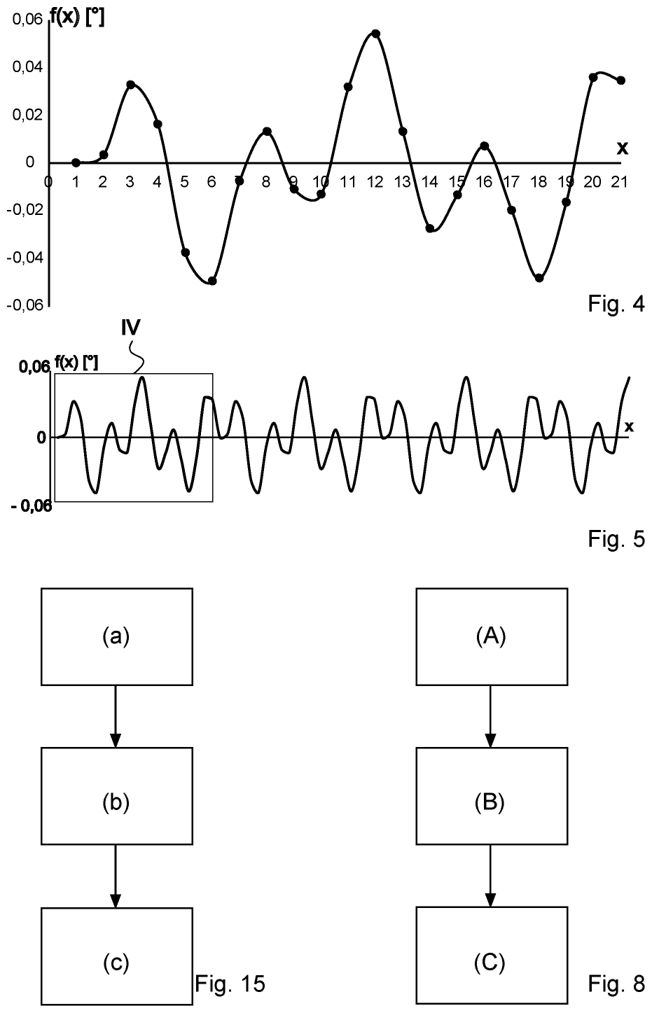

The example of FIG. 4 relates to a bevel gear having 21 teeth, wherein each tooth is assigned the deviation as the function value f(x) according to the following general rule

$$f ( x ) = {K}_{max} * {A}_{1} * sin ( 2 * π * ( {ϕ}_{1} + {ω}_{1} \frac{( x - 1 )}{Z} ) ) + {K}_{max} * {A}_{2} * sin ( 2 * π * ( {ϕ}_{2} + {ω}_{2} \frac{( x - 1 )}{Z} ) ) + {K}_{max} * {A}_{3} * sin ( 2 * π * ( {ϕ}_{3} + {ω}_{3} \frac{( x - 1 )}{Z} ) ) ,$$

for which the following numeric values are used in the present example according to FIG. 4

$$f ( x ) = 0.1 ° * 0.4 * sin ( 2 * π * ( 0.11 + 2 * \frac{( x - 1 )}{21} ) ) + 0.1 ° * 0.3 * sin ( 2 * π * ( 0.66 + 5 * \frac{( x - 1 )}{21} ) ) + 0.1 ° * 0.3 * sin ( 2 * π * ( 0 + 19 * \frac{( x - 1 )}{21} ) ) ,$$

wherein for the first sine function the amplitude A₁=0.4, the frequency ω₁=2, and the phase shift ϕ₁=0.11 are specified, wherein for the second sine function the amplitude A₂=0.3, the frequency ω₂=5, and the phase shift ϕ₂=0.66 are specified, and wherein for the third sine function the amplitude A₃=0.3, the frequency ω₃=11, and the phase shift ϕ₃=0 are specified. Kₘₐₓ corresponds in this example to a spiral angle deviation of an average spiral angle βₘ of at most 0.1°, which is superimposed by means of the sine functions on the teeth of the gearwheel. The following deviations f(x) in [° ] result therefrom for each tooth 1 to 21, (see FIG. 4):

| tooth | $\begin{matrix}{\sum }_{i = 1}^{n} {A}_{i} * \\ sin ( 2 * π * ( {ϕ}_{i} + {ω}_{i} \frac{( x - 1 )}{Z} ) )\end{matrix}$ | $\begin{matrix}{K}_{max} * {\sum }_{i = 1}^{n} {A}_{i} * \\ sin ( 2 * π * ( {ϕ}_{i} + {ω}_{i} \frac{( x - 1 )}{Z} ) )\end{matrix}$ |
|---|---|---|
| 1 | 0.002 | 0.0002° |
| 2 | 0.036 | 0.0036° |
| 3 | 0.327 | 0.0327° |
| 4 | 0.164 | 0.0164° |
| 5 | −0.376 | −0.0376° |
| 6 | −0.493 | −0.0493° |
| 7 | −0.075 | −0.0075° |
| 8 | 0.131 | 0.0131° |
| 9 | −0.108 | −0.0108° |
| 10 | −0.131 | −0.0131° |
| 11 | 0.318 | 0.0318° |
| 12 | 0.541 | 0.0541° |
| 13 | 0.133 | 0.0133° |
| 14 | −0.273 | −0.0273° |
| 15 | −0.133 | −0.0133° |
| 16 | 0.072 | 0.0072° |
| 17 | −0.196 | −0.0196° |
| 18 | −0.482 | −0.0482° |
| 19 | −0.165 | −0.0165° |
| 20 | 0.360 | 0.0360° |
| 21 | 0.347 | 0.0347° |

In FIG. 5, the function f(x) has been shown for function values from x=1 to x=75, in order to better illustrate the superimposed harmonic sine functions. The illustration of FIG. 4 is therefore a detail IV from FIG. 4.

All numeric values are to be understood solely as an example to illustrate the procedure according to the disclosure.

A deviation from the setpoint geometry, which results due to the modification superimposed on the setpoint geometry and is averaged over three or four teeth of the gearwheel according to the example of FIG. 4, is less than 25% of the total amplitude of the superposition of the sine functions. Three or four teeth are typically observed, which have a spacing of five or six teeth to one another, i.e., are arranged distributed over the circumference.

For the preceding examples, the frequency of a respective harmonic function, which corresponds to a number of cycles of the respective harmonic function observed over the total number of teeth, is less than the total number of teeth of the respective gearwheel.

For the preceding examples, the amplitudes of the superimposed harmonic functions cancel out for the tooth 1 of the respective gearwheel and the modification for this tooth of the gearwheel is essentially zero.

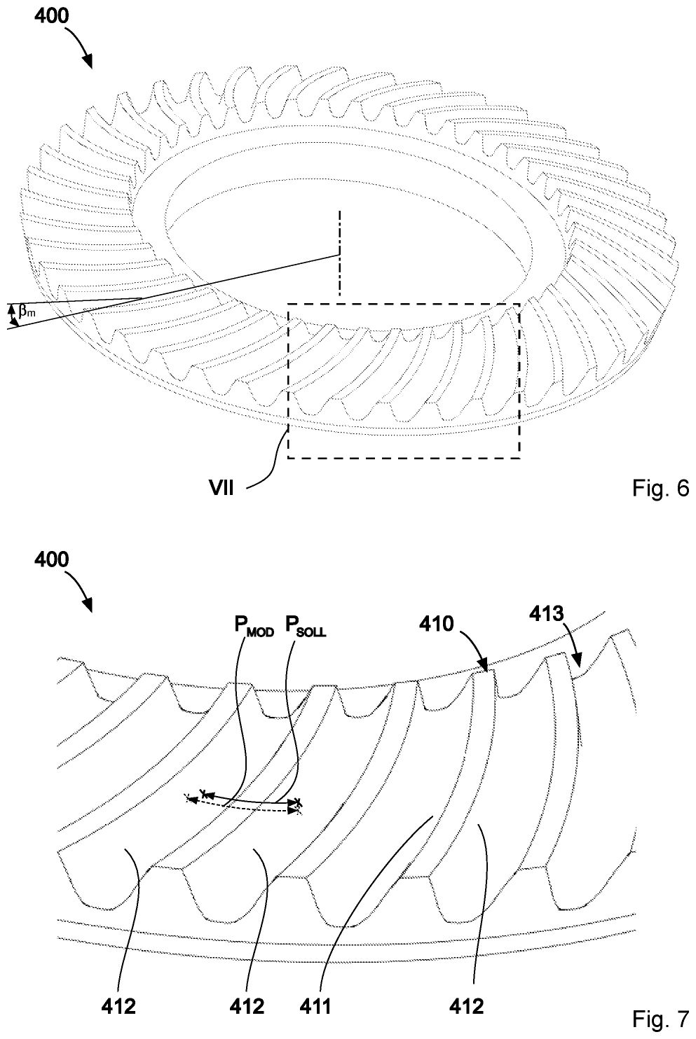

The above-described modification can be used for a bevel gear 400 (FIG. 6). The bevel gear 400 has teeth 410 and gaps 413 having concave flanks 411 and convex flanks 412. A pitch P_{SOLL} provided according to the setpoint geometry of the bevel gear and a modified pitch P_{MOD}, which results from the noise-optimized setpoint geometry of the bevel gear, are shown in an exemplary and schematic manner fora tooth of the bevel gear.

The modification can be specified for the bevel gear 400 in the form of a pitch and topography changing from tooth to tooth. In particular, it can be provided that a variation of the pitch and topography specified by the modification, observed over the total number of teeth of the bevel gear 400, corresponds to a superposition of at least two harmonic functions, which differ from one another in one parameter or in multiple parameters, such as their amplitude, frequency, or phase shift.

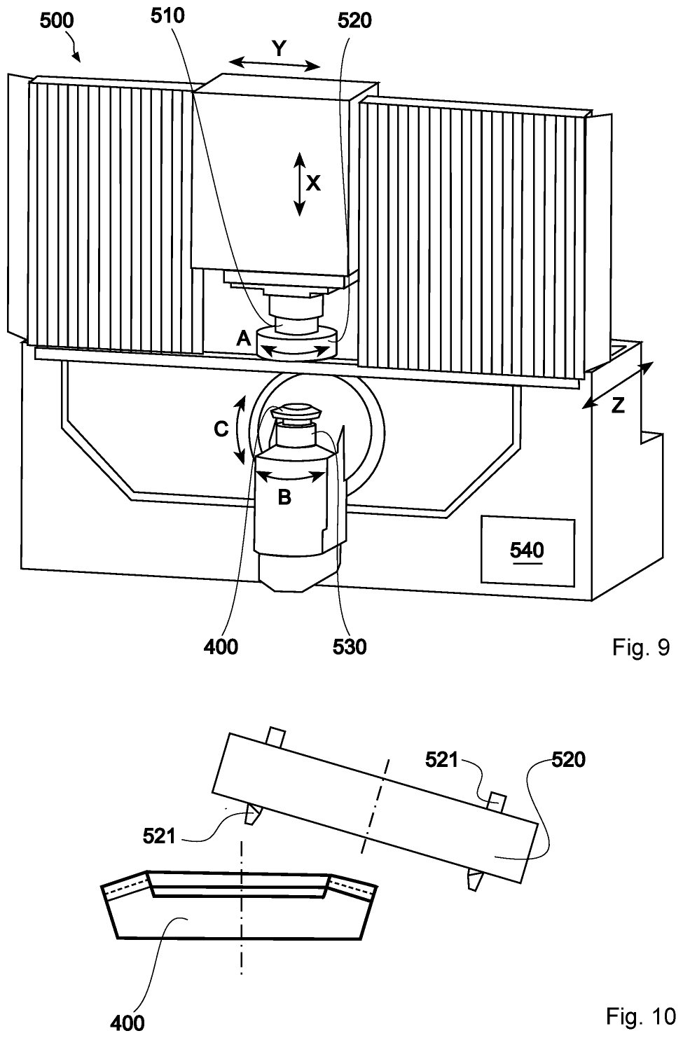

According to the disclosure, a method for producing a gearwheel 100, 400 can be specified (FIG. 8), having the method steps: (A) specifying a setpoint geometry of the gearwheel; (B) specifying a modification superimposed on the setpoint geometry in the form of a pitch and/or topography changing from tooth to tooth, wherein a variation of the pitch and/or topography specified by the modification, observed over a total number of teeth of the gearwheel, corresponds to a superposition of at least two harmonic functions, which differ from one another in one parameter or in multiple parameters, such as their amplitude, frequency, or phase shift; (C) producing the gearwheel by means of a gear cutting machine 500 (FIG. 9).

FIG. 9 shows by way of example a gear cutting machine 500 for producing bevel gear teeth. Such a gear cutting machine 500 has movement axes in the form of three linear axes X, Y, Z, an axis A for rotationally driving the one tool 520 for the bevel gear production, such as a bar cutter head or the like, an axis B for rotationally moving the bevel gear workpiece 400, and a pivot axis C for inclining the workpiece 400 relative to the tool 520. The tool 520 is held on a tool spindle 510 and the workpiece 400 is held on a workpiece spindle 530.

FIG. 10 shows the bar cutter head 520 having bar cutters 521 and the bevel gear 400.

It can be provided that the manufacturing of each gap 413 of the bevel gear 400 is carried out using gap-specific machine settings, in order to manufacture the setpoint geometry with the superimposed modification, wherein the bevel gear 400 is produced in the single indexing method. In this case, the gear cutting machine 500 receives a complete gap-specific data set for each gap 413, which possibly comprises gap-specific settings, i.e., settings differing from gap to gap, for each of the machine axes.

Alternatively, you can be provided that a manufacturing parameter of the gear cutting machine 500, such as a movement of one of the linear axes X, Y, Z or the workpiece axis B or the pivot axis C is varied specifically by gap in order to manufacture the setpoint geometry having the superimposed modification. The modification can thus be applied to the bevel gear as a gap-specific function of a single machine axis, while the further machine axes are moved for all gaps in the same manner.

It can be provided that the bevel gear 400 is produced in the single indexing method, wherein a design parameter of a virtual gear cutting machine, such as a radial ϕ for influencing the spiral angle or the like, which are converted into manufacturing parameters of the gear cutting machine 500, is varied specifically by gap in order to manufacture the setpoint geometry having the superimposed modification.

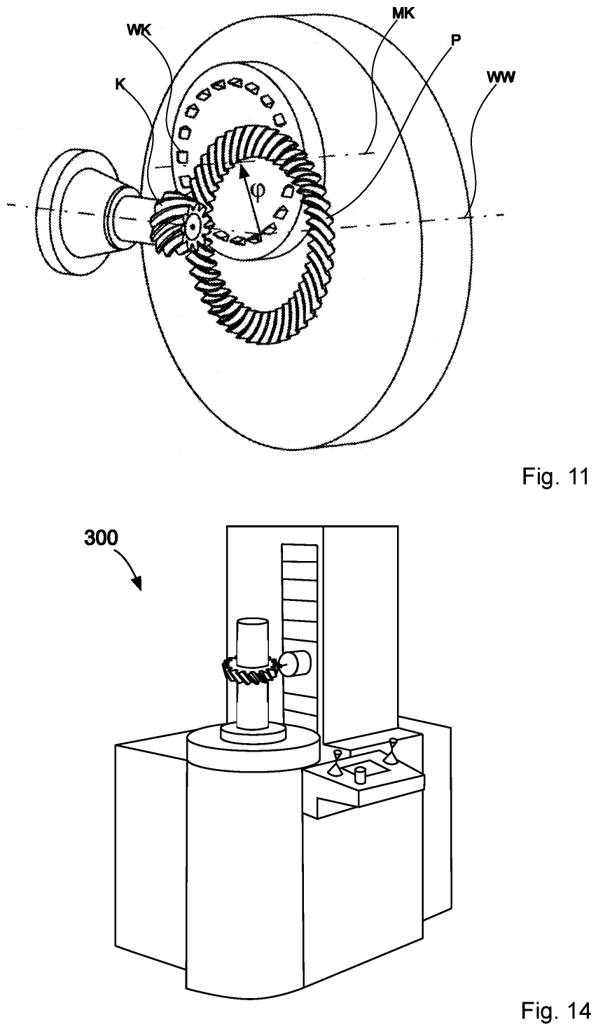

The radial ϕ in bevel gear production designates the spacing of a cutterhead axis MK to a roller cradle axis WW or roller cradle WW, which coincides in the present case with a crown gear axis of a virtual crown gear P (FIG. 11). The tool WK maps a tooth of the virtual crown gear P during the production of a bevel gear K and is pivoted for this purpose around the roller cradle WW.

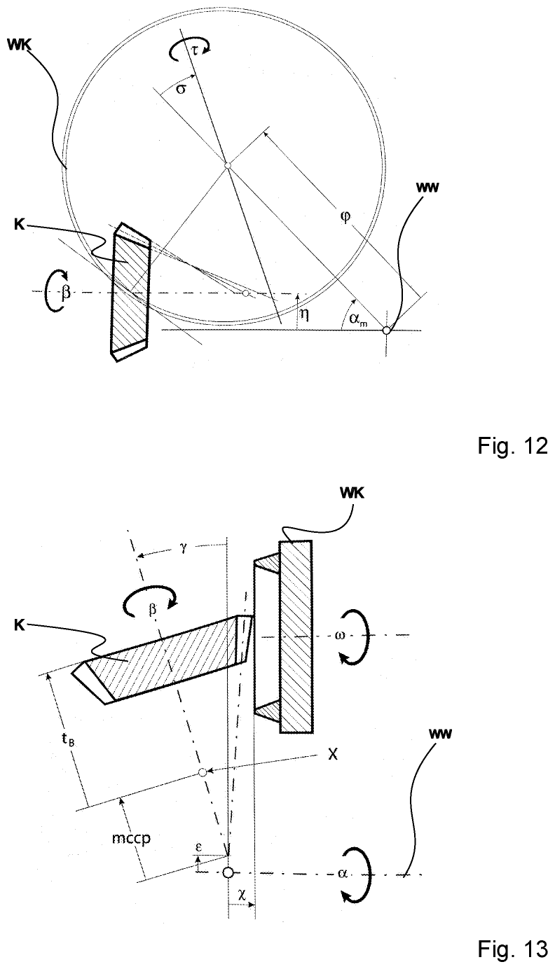

FIGS. 12 and 13 show design parameters of a virtual gear cutting machine, which are used to describe the movements between the bevel gear workpiece K and the tool WK. FIG. 12 shows a further schematic illustration of the bevel gear K, with the tool WK, the roller cradle axis WW, and the radial φ. Furthermore, a machining wheel rotational angle β, a pivot angle σ, a tilt angle τ, an axial offset η, and an average cradle angle αₘ are shown.

The illustration according to FIG. 13 schematically shows the bevel gear K, the tool WK, the roller cradle axis WW, a cradle angle α, the machining wheel rotational angle β, an element angle γ, a horizontal ε, a depth position λ, an installation dimension t_{B}, an intersection point X, and a spacing mccp of a machine center to the intersection point.

On the basis of the above-mentioned design parameters of the virtual gear cutting machine, the relative movements between the tool and the workpiece can be described independently of the machine. A finished design carried out on the basis of the virtual gear cutting machine can then be converted specifically by machine into axial movements of machine axes of a gear cutting machine, such as the gear cutting machine 500.

The modification superimposed on the setpoint geometry in the form of a pitch and/or topography changing from tooth to tooth can already be taken into consideration during the design on the basis of the virtual gear cutting machine, and can be mapped by one or more of the above-mentioned parameters of the virtual gear cutting machine. The modification superimposed on the setpoint geometry in the form of a pitch and/or topography changing from tooth to tooth is already part of the machine data converted for the machine axes in this case.

Furthermore, a method is specified according to the disclosure (FIG. 15), having the following method steps: (a) providing a gearwheel 100, 400 according to the disclosure and (b) measuring the gearwheel 100, 400 by means of a toothing measuring machine 300 (FIG. 14), wherein deviations of the gearwheel 100, 400 from the setpoint geometry are ascertained, wherein the modification superimposed on the setpoint geometry is not part of the setpoint geometry.

A number of teeth is measured on the gearwheel 100, 400 which is less than the total number of teeth of the gearwheel 100, 400, wherein in particular less than half of the teeth of the gearwheel 100, 400 are measured and in the present case precisely three or four teeth of the gearwheel 100, 400 distributed around the circumference are measured. An average deviation from the setpoint geometry is determined on the basis of the measured teeth.

In a step (c) corrections for grinding method of the gearwheel 100, 400 are determined on the basis of the average deviations.

The toothing measuring machine 300 can include a tactile sensor 310 and/or an optical sensor 320 for toothing measurement.

1. A gearwheel,
wherein the gearwheel has a setpoint geometry,
wherein the gearwheel has a modification superimposed on the setpoint geometry in the form of a pitch and/or topography changing from tooth to tooth,
wherein
a variation of the pitch and/or topography specified by the modification, observed over a total number of teeth of the gearwheel corresponds to a superposition of at least two harmonic functions, which differ from one another in one parameter or in multiple parameters, such as their amplitude, frequency, or phase shift.

2. The gearwheel according to claim 1,
wherein
the modification is specified in that a deviation is assigned to each tooth as a function value of the superimposed harmonic function.

3. The gearwheel according to claim 2,
wherein
the superimposed harmonic functions are sine functions, wherein the deviation is assigned to each tooth as a function value f(x) according to the following rule:
$$f ( x ) = {K}_{max} * {\sum }_{i = 1}^{n} {A}_{i} * sin ( 2 * π * ( {ϕ}_{i} + {ω}_{i} \frac{( x - 1 )}{Z} ) ) ,$$
wherein Kₘₐₓ corresponds to a maximum deviation of a toothing parameter or a process parameter,
wherein “i” corresponds to a running index,
wherein “n” corresponds to a number of the specified superimposed sine functions,
wherein the variable “Z” corresponds to the total number of teeth of the gearwheel,
wherein the variable “A” corresponds to a specified amplitude of a respective “i”-th sine function,
wherein the variable “ϕᵢ”: corresponds to a specified phase shift of a respective “i”-th sine function,
wherein the variable “ωᵢ” corresponds to a specified frequency of a respective “i”-th sine function,
and wherein the variable “x” is a natural number with x=1 to x=Z, wherein “x” corresponds to a number of a relevant tooth increasing from 1 to Z, and wherein the teeth are continuously numbered successively clockwise or counterclockwise.

4. The gearwheel according to claim 1,
wherein the variation of the pitch and/or topography specified by the modification, observed over the total number of teeth of the gearwheel, corresponds to a superposition of precisely three sine functions.

5. The gearwheel according to claim 1,
wherein a deviation from the setpoint geometry, resulting due to the modification superimposed on the setpoint geometry and averaged over two or more teeth of the gearwheel, corresponds to less than 30% of a total amplitude of the superposition of the at least two harmonic functions.

6. The gearwheel according to claim 1,
wherein the frequency of the respective harmonic function, which corresponds to a number of cycles of the respective harmonic function observed over the total number of teeth, is less than the total number of teeth of the gearwheel.

7. The gearwheel according to claim 1,
wherein the amplitudes of the superimposed harmonic functions cancel out for at least one tooth of the gearwheel or for precisely one tooth of the gearwheel and the modification for this tooth of the gearwheel is zero.

8. The gearwheel according to claim 1,
wherein the setpoint geometry has toothing modifications, such as recesses, crowning, or the like
and/or
the gearwheel is a bevel gear in particular is a bevel gear produced by single indexing.

9. A method for producing a gearwheel, the method including the following steps:
specifying a setpoint geometry of the gearwheel,
specifying a modification superimposed on the setpoint geometry in the form of a pitch and/or topography changing from tooth to tooth, and
producing the gearwheel by means of a gear cutting machine, wherein
a variation of the pitch and/or topography specified by the modification, observed over a total number of teeth of the gearwheel, corresponds to a superposition of at least two harmonic functions which differ from one another in one parameter or in multiple parameters, such as their amplitude, frequency, or phase shift.

10. The method according to claim 9,
wherein
the manufacturing of each gap of the gearwheel is carried out using gap-specific machine settings, in order to manufacture the setpoint geometry having the superimposed modification, wherein the gearwheel is in particular a bevel gear that is produced in the single indexing method;
or
the gearwheel is a bevel gear that is produced in the single indexing method, wherein a design parameter of a virtual gear cutting machine, such as a radial for influencing the spiral angle or the like, which are converted into manufacturing parameters of the gear cutting machine, is varied specifically by gap in order to manufacture the setpoint geometry having the superimposed modification;
or
a manufacturing parameter of the gear cutting machine, such as a movement of a linear axis or a workpiece axis, is varied specifically by gap in order to manufacture the setpoint geometry having the superimposed modification.

11. The method according to claim 9,
wherein
the modification is specified in that a deviation is assigned to each tooth as a function value of the superimposed harmonic function,
the superimposed harmonic functions are sine functions, wherein the deviation is assigned to each tooth as a function value f(x) according to the following rule:
$$f ( x ) = {K}_{max} * {\sum }_{i = 1}^{n} {A}_{i} * sin ( 2 * π * ( {ϕ}_{i} + {ω}_{i} \frac{( x - 1 )}{Z} ) ) ,$$
wherein Kₘₐₓ, corresponds to a maximum deviation of a toothing parameter or a process parameter,
wherein “i” corresponds to a running index, wherein “n” corresponds to a number of the specified superimposed sine functions,
wherein the variable “Z” corresponds to the total number of teeth of the gearwheel,
wherein the variable “Aᵢ” corresponds to a specified amplitude of a respective “i”-th sine function,
wherein the variable “ϕᵢ” corresponds to a specified phase shift of a respective “i”-th sine function,
wherein the variable “ωᵢ” corresponds to a specified frequency of a respective “i”-th sine function,
and wherein the variable “x” is a natural number with x=1 to x=Z, wherein “x” corresponds to a number of a relevant tooth increasing from 1 to Z, and wherein the teeth are continuously numbered successively clockwise or counterclockwise.

12. The method according to claim 9,
wherein the variation of the pitch and/or topography specified by the modification, observed over the total number of teeth of the gearwheel, corresponds to a superposition of precisely three sine functions.

13. A method, having the following steps:
providing a gearwheel, wherein the gearwheel is designed according to claim 1, and
measuring the gearwheel by means of a toothing measuring machine, wherein deviations of the gearwheel from the setpoint geometry are ascertained, wherein the modification superimposed on the setpoint geometry is not part of the setpoint geometry.

14. The method according to claim 13,
wherein
a number of teeth are measured on the gearwheel which is less than the total number of teeth of the gearwheel,
wherein an average deviation from the setpoint geometry is determined on the basis of the measured teeth.

15. The method according to claim 14,
wherein
corrections for a grinding method of the gearwheel are determined on the basis of the average deviations.
